(19) United States
(12) Patent Application Publication
(10) Pub. No.: US 2015/0036770 A1
(43) Pub. Date: Feb. 5, 2015

(54) RECEPTION APPARATUS AND RECEPTION METHOD

(71) Applicant: Kabushiki Kaisha Toshiba, Tokyo (JP)

(72) Inventors: Koji Horisaki, Yokohama-Shi (JP); Toshiyuki Yamagishi, Tokyo (JP)

(73) Assignee: KABUSHIKI KAISHA TOSHIBA, Tokyo (JP)

(21) Appl. No.: 14/170,850

(22) Filed: Feb. 3, 2014

(30) Foreign Application Priority Data
Aug. 2, 2013 (JP) 2013-161249

(51) Int. Cl. H04L 1/00; H04L 27/26

(52) U.S. Cl. CPC H04L 1/0048; H04L 27/2649
USPC 375/340

(57) ABSTRACT

According to one embodiment, a reception apparatus is configured to receive a radio signal comprising a plurality of modulated subcarriers. The reception apparatus has a demodulator, a subcarrier specification module, and an error correction decoder. The demodulator is configured to demodulate the radio signal to generate the subcarriers. The subcarrier specification module is configured to specify a subcarrier whose frequency overlaps with a spurious frequency among the subcarriers. The error correction decoder is configured to perform error correction, relying more on the subcarriers whose frequencies do not overlap with the spurious frequency than on the subcarrier whose frequency overlaps with the spurious frequency.

### CROSS REFERENCE TO RELATED APPLICATIONS

This application is based upon and claims the benefit of priority from the prior Japanese Patent Application No. 2013-161249, filed on Aug. 2, 2013, the entire contents of which are incorporated herein by reference.

### FIELD

Embodiments described herein relate generally to a reception apparatus and a reception method.

### BACKGROUND

When there is a spurious component resulting from a clock or the like for a digital circuit in a reception apparatus that receives radio signals, the spurious component interferes with a received signal, and thus, reception performance might be degraded.

### BRIEF DESCRIPTION OF THE DRAWINGS

FIG. 1 is a diagram schematically showing a relationship between subcarriers 1 obtained by demodulating a received radio signal, and a spurious component 2.

FIG. 2 is a diagram showing an example format of a radio signal packet.

FIG. 3 is a block diagram schematically showing the structure of a reception apparatus 100 according to a first embodiment.

FIGS. 4A and 4B are schematic diagrams for explaining an operation of the weight multiplier 17.

FIG. 5 is a schematic diagram for explaining operations of the weight multiplier 17 and the error correction decoder 18.

FIGS. 6A and 6B are schematic diagrams for explaining another operation of the weight multiplier 17.

FIGS. 7A and 7B are schematic diagrams for explaining yet another operation of the weight multiplier 17.

FIG. 8 is a diagram showing an example of a table stored in the storage 42.

FIG. 9 is a flowchart showing an outline of a processing operation of the reception apparatus 100.

FIG. 10 is a block diagram schematically showing the structure of a reception apparatus 101 according to the second embodiment.

FIGS. 11A and 11B are diagrams for explaining a processing operation of the smoothing module 19.

FIG. 12 is a block diagram showing an example internal structure of the smoothing module 19.

FIG. 13 is a flowchart showing an example of a processing operation of the smoothing module 19.

### DETAILED DESCRIPTION

In general, according to one embodiment, a reception apparatus is configured to receive a radio signal comprising a plurality of modulated subcarriers. The reception apparatus has a demodulator, a subcarrier specification module, and an error correction decoder.

The demodulator is configured to demodulate the radio signal to generate the subcarriers. The subcarrier specification module is configured to specify a subcarrier whose frequency overlaps with a spurious frequency among the subcarriers. The error correction decoder is configured to perform error correction, relying more on the subcarriers whose frequencies do not overlap with the spurious frequency than on the subcarrier whose frequency overlaps with the spurious frequency.

The following is a detailed description of embodiments, with reference to the drawings.

### First Embodiment

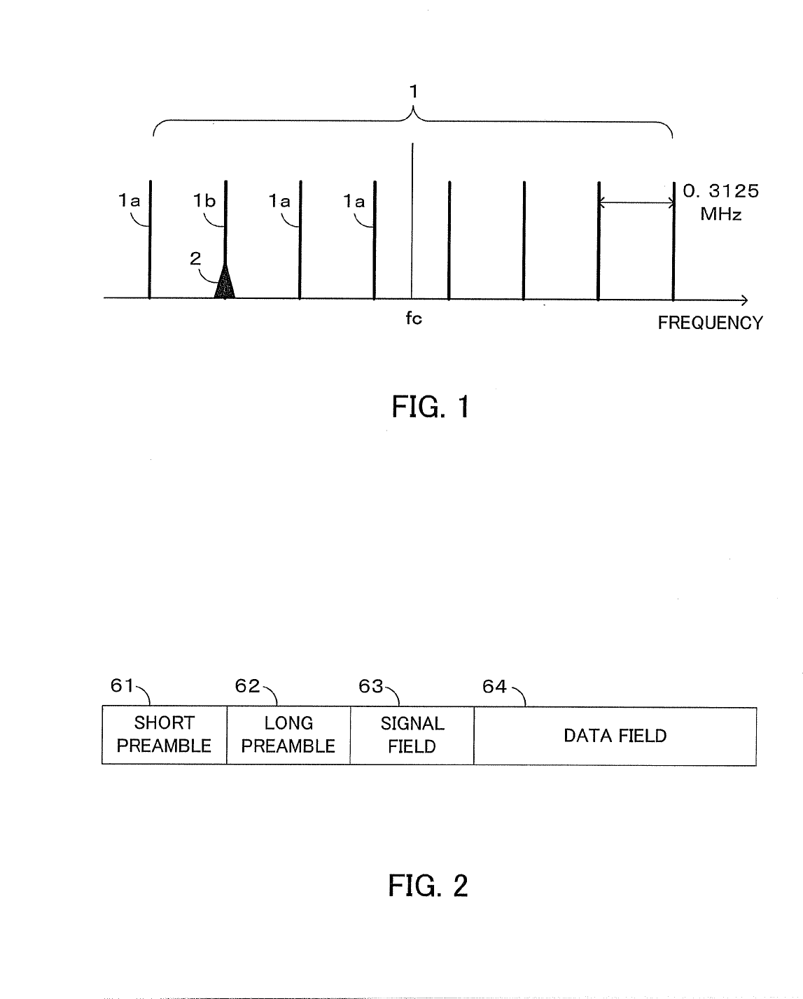

Firstly, an outline of this embodiment will be described. FIG. 1 is a diagram schematically showing a relationship between subcarriers 1 obtained by demodulating a received radio signal, and a spurious component 2. The present embodiment is based on an assumption that OFDM (orthogonal frequency division multiplexing)-modulated multicarriers are wirelessly transmitted.

The principal specification of the subcarriers 1 is defined in the standards. For example, according to the 2.4-GHz band wireless LAN (IEEE802.11n 20 MHz mode) standard, the frequency intervals between the subcarriers 1 are 0.3125 MHz (equal spacing), and the number of subcarriers is 56 (±28 with respect to a center frequency fc). There are approximately 11 possible center frequencies fc in the vicinity of 2.4 GHz. When a wireless LAN is connected, one center frequency fc is determined in accordance with the connected base station, and the frequency of each subcarrier 1 is also determined in accordance with the center frequency fc. During a communication, the center frequency fc hardly changes.

Each of the subcarriers 1 contains information represented by one or more bits. A radio signal has redundancy for error correction so that, even if an error occurs while one subcarrier 1 is being demodulated, the error can be corrected by using another subcarrier 1.

The spurious component 2 is any of various kinds of frequency signals that might degrade radio signals. The present embodiment is based on an assumption that the frequency of the spurious component 2 can be predicted. For example, the frequency of the spurious component 2 relates to a clock signal of a reception apparatus that receives and demodulates radio signals. More specifically, the harmonics of an oscillation signal of a crystal oscillator that generates the source oscillation signal of the clock signal might be the spurious component 2. Accordingly, the frequency of the spurious component 2 can be predicted from the oscillating frequency unique to the crystal oscillator.

In the drawing, subcarriers 1a whose frequency is far from the spurious component 2 hardly interfere with the spurious component 2, and accordingly, the possibility of an occurrence of an error at the time of demodulation is low. Meanwhile, a subcarrier 1b whose frequency overlaps with the frequency of the spurious component 2 (hereinafter, also referred to as spurious frequency) may be degraded by interference with the spurious component 2, and the possibility of an occurrence of an error at the time of demodulation is high.

Therefore, in this embodiment, the frequency of the spurious component 2 is predicted, and an error correction process is performed by relying more on the subcarriers 1a whose frequency does not overlap with frequency of the spurious component 2 than on the subcarrier 1b whose frequency overlaps with the frequency of the spurious component 2. This will be described in detail.

FIG. 2 is a diagram showing an example format of a radio signal packet. A radio signal includes a short preamble 61, a long preamble 62, a signal field 63, and a data field 64.

The short preamble 61 is a known signal located at the top of the packet, and is used for gain control and coarse frequency control. The long preamble 62 is a known signal following the short preamble 61, and is used for transmission channel response estimation and frequency control. The signal field 63 contains information such as a data rate and a data length. The data field 64 contains information.

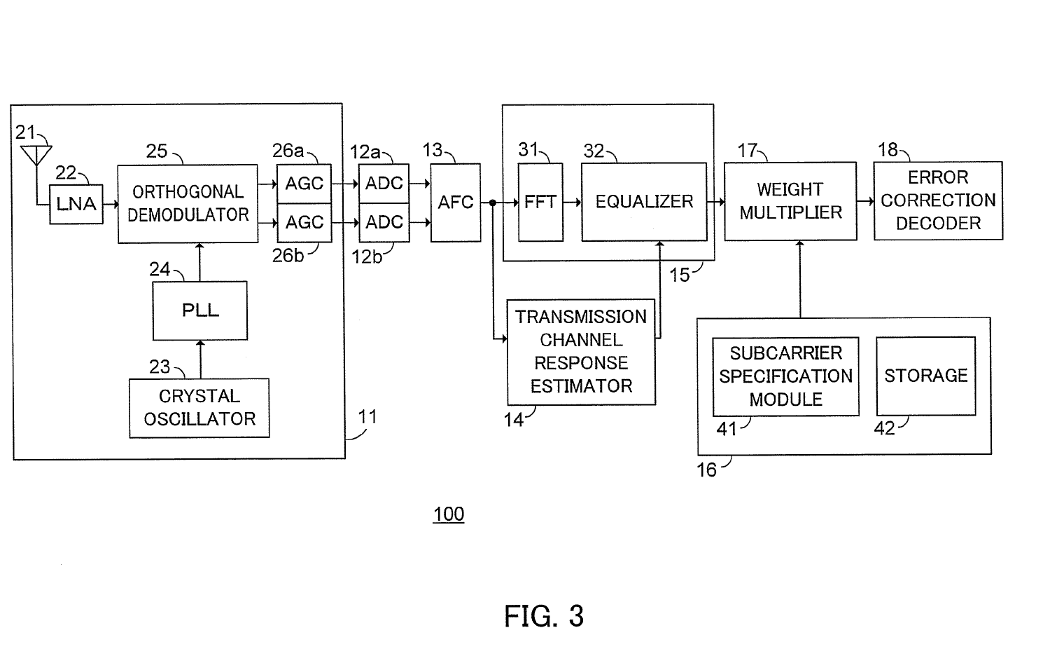

FIG. 3 is a block diagram schematically showing the structure of a reception apparatus 100 according to a first embodiment. This reception apparatus 100 receives the radio signal shown in FIG. 2. The reception apparatus 100 is mounted on a personal computer or a wireless LAN (Local Area Network) terminal such as a smartphone.

The reception apparatus 100 includes a radio processor 11, AD converters (ADC) 12a and 12b, an auto frequency controller (AFC) 13, a transmission channel response estimator 14, a demodulator 15, a controller 16, a weight multiplier 17, and an error correction decoder 18. The respective components in the reception apparatus 100 may be formed on one or more semiconductor chips, or some of the components may be implemented by software. In one example, the controller 16 may be implemented by software, and the other components may be formed on a single semiconductor chip.

The radio processor 11 converts a radio signal into a baseband signal, and includes an antenna 21, a low noise amplifier (LNA) 22, a crystal oscillator 23, a PLL module 24, an orthogonal demodulator 25, and auto gain controllers (AGC) 26a and 26b.

The antenna 21 receives the radio signal shown in FIG. 2. The LNA 22 amplifies the received radio signal. The crystal oscillator 23 generates the source oscillation signal of a clock signal. The oscillating frequency f0 of the crystal oscillator 23 is 13 MHz, for example, and the frequency of the source oscillation signal in this case is 13 MHz. The PLL module 24 generates a clock signal from the source oscillation signal. The frequency of the clock signal is an integral multiple of the frequency of the source oscillation signal. The orthogonal demodulator 25 is a mixer, for example, and performs orthogonal demodulation on the radio signal by using the clock signal generated by the PLL module 24, to generate a baseband signal formed with an I-signal and a Q-signal. The AGCs 26a and 26b amplify the I-signal and the Q-signal respectively to a predetermined level in accordance with the reception intensity of the radio signal.

The ADCs 12a and 12b convert the I-signal and the Q-signal respectively outputted from the radio processor 11 into digital signals. The AFC 13 performs coarse frequency control by using the short preamble 61 contained in the digitized radio signal, and also performs fine frequency control by using the long preamble 62.

The transmission channel response estimator 14 estimates distortion to be caused in the radio signal in the transmission channel. More specifically, the transmission channel response estimator 14 estimates how the amplitude and phase change when the respective subcarriers are transmitted from a transmission apparatus (not shown) to the reception apparatus 100 by using the long preamble 62 with a known amplitude and a known phase.

The demodulator 15 demodulates the digitized radio signal. More specifically, the demodulator 15 includes an FFT module 31 and an equalizer 32. The FFT module 31 performs an FFT process on the digital signal, to convert the digital signal into a frequency domain signal. The equalizer 32 corrects the distortion caused in the radio signal in the transmission channel by using the result of the transmission channel response estimation. As a result, the subcarriers 1 shown in FIG. 1 are generated. Each of the subcarriers 1 contains information represented by one or more bits.

The controller 16 includes a subcarrier specification module 41 and a storage 42.

The subcarrier specification module 41 first calculates the frequency of the spurious component 2 based on the oscillating frequency f0 of the crystal oscillator 23. Further, the subcarrier specification module 41 specifies the subcarrier 1b whose frequency is substantially the same as the frequency of the spurious component 2 among the subcarriers 1 based on the center frequency fc of the radio signal, the frequency intervals fa between the subcarriers 1, and the number n of the subcarriers 1. A specific example according to the 2.4-GHz band wireless LAN (IEEE802.11n 20 MHz mode) standard is now described under the following assumptions.
The frequency f0 of the source oscillation signal generated by the crystal oscillator 23 is 13 MHz
The center frequency fc of the radio signal is 2412 MHz
The frequency intervals fa between the subcarriers 1 are 0.3125 MHz
The number n of the subcarriers 1 is ±28 (Subcarriers whose frequencies are higher than the center frequency fc are positive, and subcarriers whose frequencies are lower than the center frequency fc are negative. A subcarrier of n=0 is not used.)

In this case, the frequency of the kth (k=−28 to 28) subcarrier 1 is (fc+fa*k)=(2412+0.3125*k) MHz.

The frequency of the spurious component 2 is an integral multiple of the frequency f0 of the source oscillation signal, which is 13 MHz. Specifically, the spurious components 2 at 1) 2392 MHz, which is 184 times higher than 13 MHz, 2) 2405 MHz, which is 185 times higher than 13 MHz, 3) 2418 MHz, which is 186 times higher than 13 MHz, or 4) 2431 MHz, which is 187 times higher than 13 MHz, are generated in the vicinity of the center frequency fc, which is 2412 MHz.

Here, the frequency of the −22nd subcarrier 1 is (2412+0.3125*(−22)) MHz, which is approximately 2405 MHz. Accordingly, this subcarrier 1 overlaps with the spurious component 2 having the 185 times higher frequency. Likewise, the frequency of the +19th subcarrier 1 is approximately 2418 MHz, and overlaps with the spurious component 2 having the 186 times higher frequency.

Among the subcarriers 1, the frequency of the −28th subcarrier 1 is the lowest, and is approximately 2403 MHz. Therefore, there are no subcarriers 1 overlapping with the spurious component 2 having a frequency equal to or lower than the 184 times higher frequency (2392 MHz). Among the subcarriers 1, the frequency of the +28th subcarrier 1 is the highest, and is approximately 2421 MHz. Therefore, there are no subcarriers 1 overlapping with the spurious component 2 having a frequency equal to or higher than the 187 times higher frequency (2431 MHz).

Accordingly, the subcarrier specification module 41 specifies the −22nd and +19th subcarriers 1b as subcarriers 1b whose frequencies overlap with the frequency of the spurious components 2.

The storage 42 stores a weight coefficient A by which the subcarriers 1b specified by the subcarrier specification module 41 are to be multiplied. For example, the weight coefficient A is set in advance by evaluating the reception apparatus 100 or conducting experiments by trial and error so that the error correction rate at the error correction decoder 18 will become higher.

The weight coefficient A is multiplied with the subcarriers 1b having a high possibility of being degraded due to overlapping of the frequency with that of the spurious 2, and therefore, is set to a value that is equal to or greater than 0 but smaller than 1. A smaller weight coefficient A means a lower reliability.

The weight coefficient A may vary with the frequency of the subcarrier to be multiplied by the weight coefficient A. For example, in a case where it is known that the spurious component 2 having the frequency 185 times higher than the frequency f0 of the source oscillation signal has larger influence of interference than the spurious component 2 having the frequency 184 times higher than the frequency f0 of the source oscillation signal in the above described example, the weight coefficient A for the +19th subcarrier that overlaps with the former may be made smaller than the weight coefficient A for the −22nd subcarrier that overlaps with the latter.

Further, a different optimum weight coefficient A may be set for each reception apparatus 100, with variations among reception apparatuses 100 being taken into account.

The weight multiplier 17 multiplies the subcarriers 1 specified by the subcarrier specification module 41, namely the subcarriers 1b whose frequency overlaps with the frequency of the spurious component 2, by a weight coefficient A stored in the storage 42.

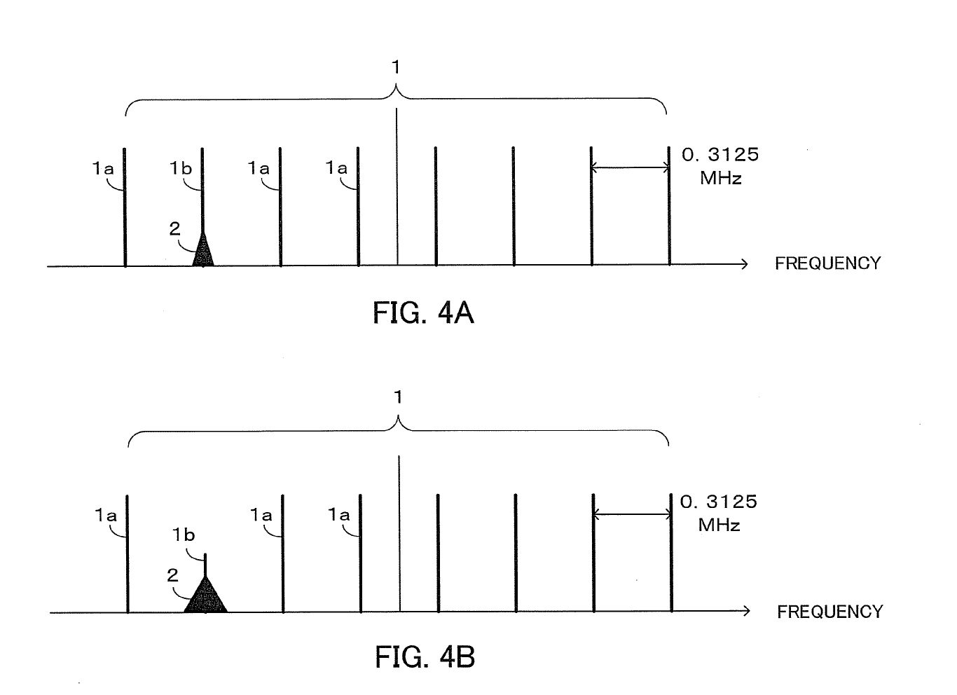

FIGS. 4A and 4B are schematic diagrams for explaining an operation of the weight multiplier 17, and show subcarriers 1 prior to a weight multiplication process (FIG. 4A) and the subcarriers 1 after the weight multiplication process (FIG. 4B). As shown in the drawing, the subcarrier 1b whose frequency overlaps with the frequency of a spurious component 2 is multiplied by a weight coefficient A that is smaller than 1. As a result, the amplitude of the subcarrier 1b whose frequency overlaps with the frequency of the spurious component 2 becomes smaller than the amplitude of the subcarriers 1a whose frequencies do not overlap with the frequency of the spurious component 2.

Referring back to FIG. 3, the error correction decoder 18 is a Viterbi decoder, for example. The error correction decoder 18 performs error correction on a demodulated signal outputted from the weight multiplier 17, and outputs the error-corrected demodulated signal. The subcarrier 1b at whose frequency overlaps with the frequency of the spurious component 2 has already been multiplied by the weight coefficient A that is smaller than 1 by the weight multiplier 17. Accordingly, the error correction decoder 18 performs an error correction process, relying more on the subcarriers 1a whose frequencies do not overlap with the frequency of the spurious component 2.

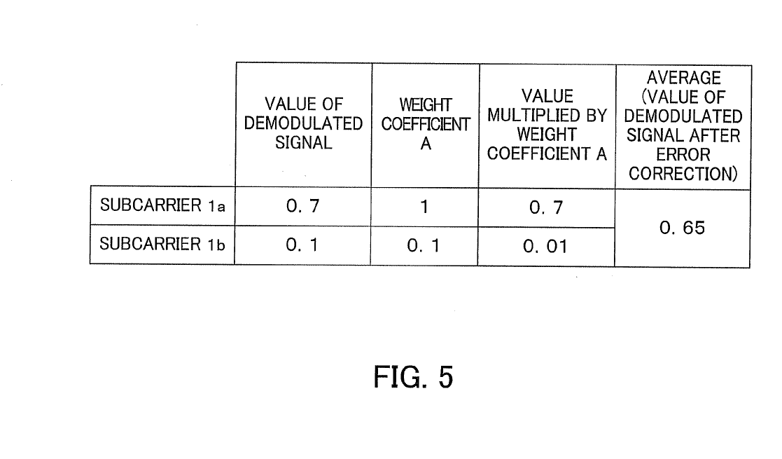

FIG. 5 is a schematic diagram for explaining operations of the weight multiplier 17 and the error correction decoder 18. For ease of explanation, one transmitted value (1 bit) is contained in both the subcarriers 1a and 1b, and the subcarriers 1a and 1b indicate the same values unless there is degradation due to the spurious component 2 or the like. Error correction is performed with such redundancy.

The value indicated by a subcarrier is normally 0 or 1. However, a subcarrier might indicate a value between 0 and 1 due to signal degradation that occurs in the process of transmission. In the example case shown in FIG. 5, the value indicated by a subcarrier is whose frequency does not overlap with the frequency of the spurious component 2 is 0.7, and the value indicated by a subcarrier 1b whose frequency overlaps with the frequency of the spurious component 2 is 0.1.

If error correction is performed by calculating the average value of the subcarriers 1a and 1b, the value after the error correction is 0.4, which becomes 0 when binarized. In reality, however, the subcarrier 1b is interfered with by the spurious component 2, and the value thereof is not necessarily reliable.

Therefore, the weight multiplier 17 is provided in this embodiment. In the example shown in the drawing, the weight multiplier 17 does not perform the weight coefficient multiplication process on the subcarrier 1a (or multiplies the subcarrier 1b by a weight coefficient of 1), and multiplies the subcarrier 1b, which is interfered with by the spurious component 2, by a weight coefficient of 0.1. As a result, the values indicated by the subcarriers 1a and 1b after the weighting process are 0.7 and 0.01, respectively. The average value of those values is (0.7+0.01)/(1+0.1)=0.65, which is 1 when binarized. In this manner, the error correction rate can be increased.

Some modifications of the weight multiplier 17, the subcarrier specification module 41, and the storage 42 will be described below.

The weight multiplier 17 multiplies at least a subcarrier specified by the subcarrier specification module 41 by a weight coefficient, and may also multiply other subcarriers by a weight coefficient.

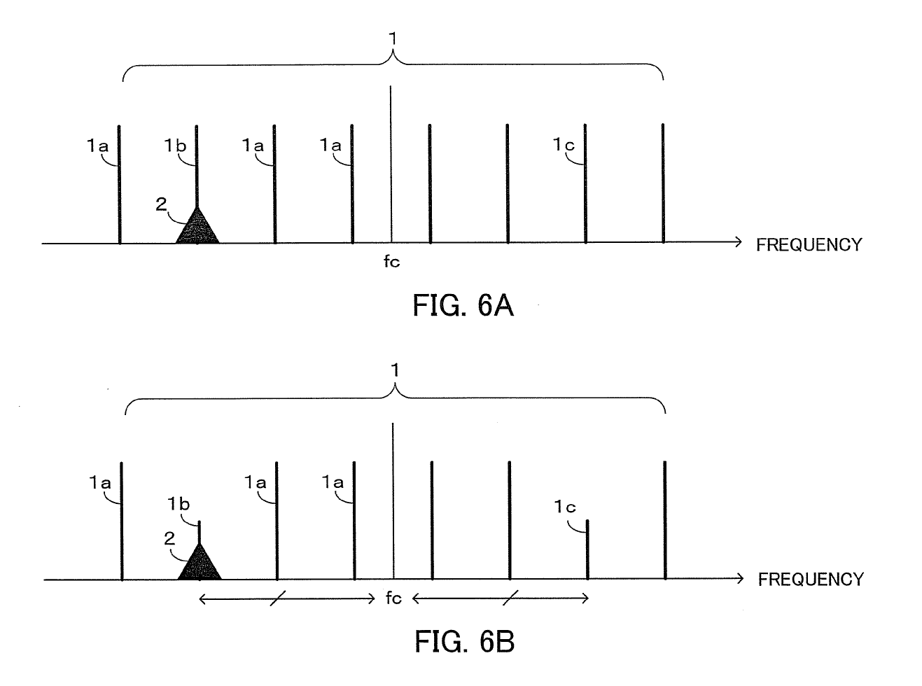

FIGS. 6A and 6B are schematic diagrams for explaining another operation of the weight multiplier 17, and show subcarriers 1 prior to a weight multiplication process (FIG. 6A) and the subcarriers 1 after the weight multiplication process (FIG. 6B). In this example, the weight multiplier 17 not only multiplies the subcarrier 1b overlapping with the spurious component 2 by a weight coefficient A, but also multiplies a subcarrier 1c at a frequency symmetrical to the subcarrier 1b with respect to the center frequency fc by a weight coefficient A′. The subcarrier 1c at the symmetrical frequency is the −kth subcarrier, as opposed to the kth subcarrier. Such a process is performed because there is a possibility that an error occurs in the symmetrical subcarrier is at the time of a demodulation process. Here, the weight coefficients A and A′ may be the same or may differ from each other.

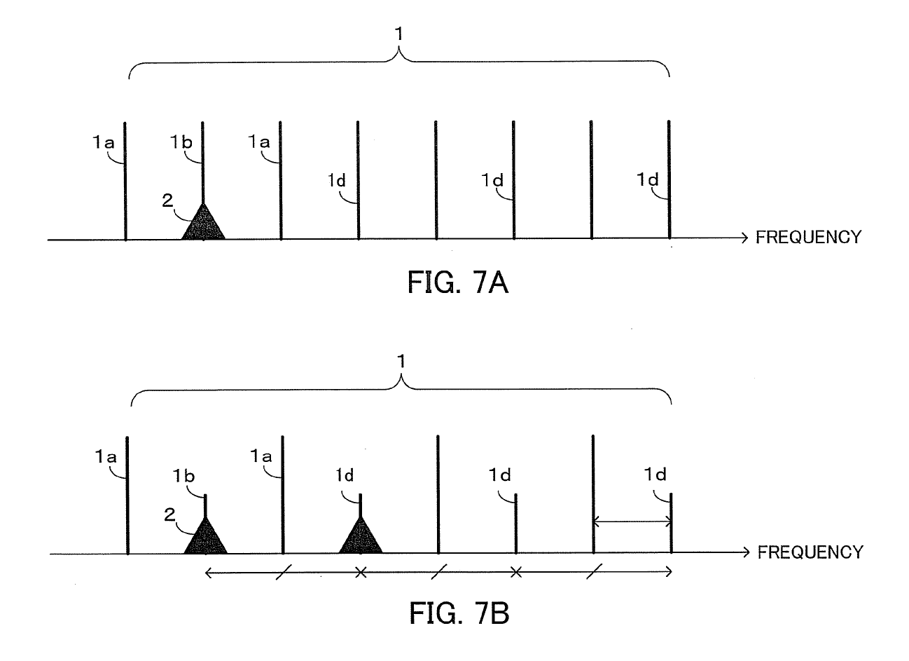

FIGS. 7A and 7B are schematic diagrams for explaining yet another operation of the weight multiplier 17, and show subcarriers 1 prior to a weight multiplication process (FIG. 7A) and the subcarriers 1 after the weight multiplication process (FIG. 7B). In this example, not only a subcarrier 1b specified by the subcarrier specification module 41 but also subcarriers at regular frequency intervals are multiplied by a weight coefficient. This is because a spurious component appears at frequencies that are integral multiples of the oscillating frequency f0 of the crystal oscillator 23.

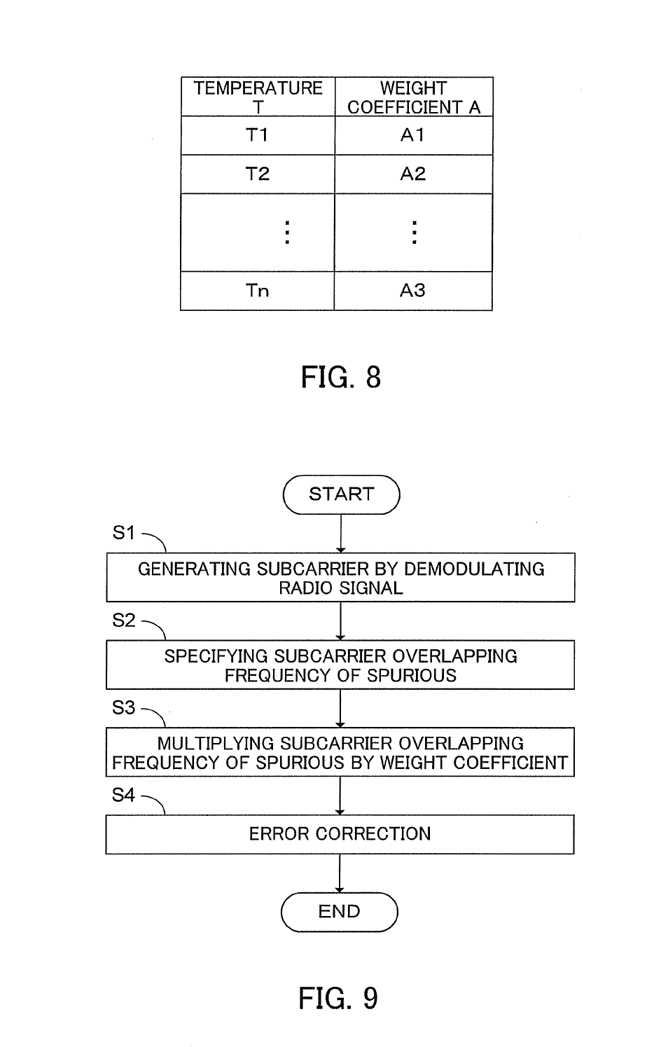

FIG. 8 is a diagram showing an example of a table stored in the storage 42. This drawing shows an example case where the storage 42 stores weight coefficients A varying with temperatures T of the reception apparatus 100 in a table. A temperature T of the reception apparatus 100 is acquired from a thermometer (not shown) installed in the reception apparatus 100, for example. The table shown in the drawing can be generated by acquiring optimum weight coefficients Ak for respective temperatures Tk based on an evaluation conducted in advance. In a case where the temperature in the reception apparatus 100 is Tk, the weight multiplier 17 multiplies a subcarrier 1b specified by the subcarrier specification module 41 by the weight coefficient Ak.

The weight multiplier 17 may acquire a temperature on a regular basis, and switch weight coefficients A to multiply the subcarrier 1b.

Also, the storage 42 may store weight coefficients A varying with communication rates in a table. So as to increase a communication rate, the one subcarrier 1 may have multiple values, or the redundancy (code rate) for error correction is reduced. Therefore, the influence of a spurious component varies with communication rates. Accordingly, the use of weight coefficients A that vary with communication rates is also effective.

Alternatively, the storage 42 may store weight coefficients A varying with the power supply voltage of the reception apparatus 100 or the intensities of received radio signals in a table. In a case where the reception intensity is sufficiently high, the influence of a spurious component 2 is not very large, and therefore, the weight coefficients A do not need to be made smaller.

In a case where weight coefficients that vary with communication rated, the power supply voltage of the reception apparatus 100, and the reception intensities of radio signals are set, evaluations and experiments are also conducted in various circumstances in advance, and optimum weight coefficients A should be set.

The subcarrier specification module 41 may not calculate the frequency of the spurious component 2, but may specify the subcarrier 1b at the same frequency as the frequency of the spurious component 2 based on a result of transmission channel response estimation performed by the transmission channel response estimator 14. As described above, the transmission channel response estimator 14 estimates a transmission channel response (namely changes in amplitude and phase) for each subcarrier 1. If there are no spurious components 2, adjacent subcarriers 1 exhibit transmission channel responses similar to each other. However, the subcarrier 1b overlapping with the spurious component 2 may be a singular point, that is, the transmission response of the subcarrier 1b overlapping with the spurious component 2 may be greatly differs from those of adjacent subcarriers 1.

In view of this, the subcarrier specification module 41 may specify a subcarrier having a transmission channel response that greatly differs from those of adjacent subcarriers 1, and set the subcarrier as the subcarrier 1b whose frequency overlaps with the frequency of the spurious component 2. By this method, the influence of spurious components other than the spurious component derived from the oscillating frequency f0 of the crystal oscillator 23 can be reduced.

Also, in a case where a Bluetooth (a registered trade name) device exists in the reception apparatus 100, the frequency of the Bluetooth and frequencies that are integral multiples of the frequency of the Bluetooth can be spurious frequencies. Also, the clock frequency used in the Bluetooth device and frequencies that are integral multiples of the clock frequency can also be spurious frequencies.

In view of this, the subcarrier specification module 41 may receive a signal indicating whether the Bluetooth device is being used (a Co-Ex signal) from the Bluetooth device, and, if the Bluetooth device is being used, specify the subcarrier overlapping with the spurious component caused by the Bluetooth device.

FIG. 9 is a flowchart showing an outline of a processing operation of the reception apparatus 100. A radio signal received by the antenna 21 is subjected to the processing performed by the radio processor 11, the ADCs 12a and 12b, and the AFC 13, and is then demodulated by the demodulator 15. As a result the subcarriers 1 shown in FIG. 1 are generated (step S1). Meanwhile, the subcarrier specification module 41 specifies the subcarrier 1b whose frequency overlaps with the frequency of the spurious component 2 among the subcarriers 1 (step S2). It should be noted that steps S1 and S2 may be reversed in order or may be simultaneously carried out.

The weight multiplier 17 then multiplies the subcarrier 1b specified by the subcarrier specification module 41 by a weight coefficient A that is equal to or greater than 0 but smaller than 1 (step S3). The error correction decoder 18 performs error correction by using the subcarriers 1 subjected to the multiplication process (step S4).

As described above, in the first embodiment, the subcarrier 1b at the same frequency as the frequency of the spurious component 2 is multiplied by a weight coefficient A that is smaller than 1. Accordingly, error correction can be performed by relying more on the subcarriers 1a at different frequencies from the frequency of the spurious component 2 than on the subcarrier 1b at the same frequency as the frequency of the spurious component 2, and higher demodulation precision is achieved. As a result, degradation of reception performance due to a spurious component can be reduced.

### Second Embodiment

In the above described first embodiment, error correction is performed, with the frequency of the spurious component 2 being taken into account. In a second embodiment described below, however, transmission channel response estimation is to be performed with high precision, with the frequency of the spurious component 2 being taken into account.

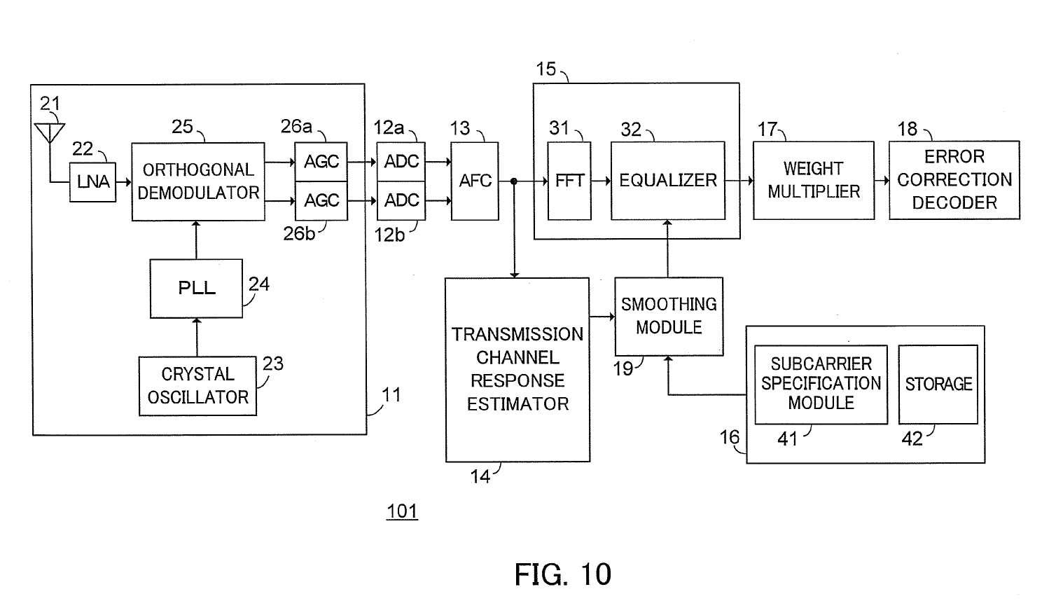

FIG. 10 is a block diagram schematically showing the structure of a reception apparatus 101 according to the second embodiment. In FIG. 10, the same components as those shown in FIG. 3 are denoted by the same reference numerals as those used in FIG. 3, and mainly the differences from the first embodiment will be described below.

The reception apparatus 101 in FIG. 10 further includes a smoothing module 19. The information about a subcarrier 1b specified by the controller 16 is used by the smoothing module 19. Specifically, the smoothing module 19 performs a smoothing process on results of transmission channel response estimation performed for respective subcarriers 1, relying more on the subcarriers 1a whose frequencies does not overlap with the frequency of the spurious component 2 than on the subcarrier 1b whose frequency overlaps of the frequency of a spurious component 2. By such a smoothing process, the precision of the transmission channel response estimation can be increased. It should be noted that the reception apparatus 101 may exclude the weight multiplier 17.

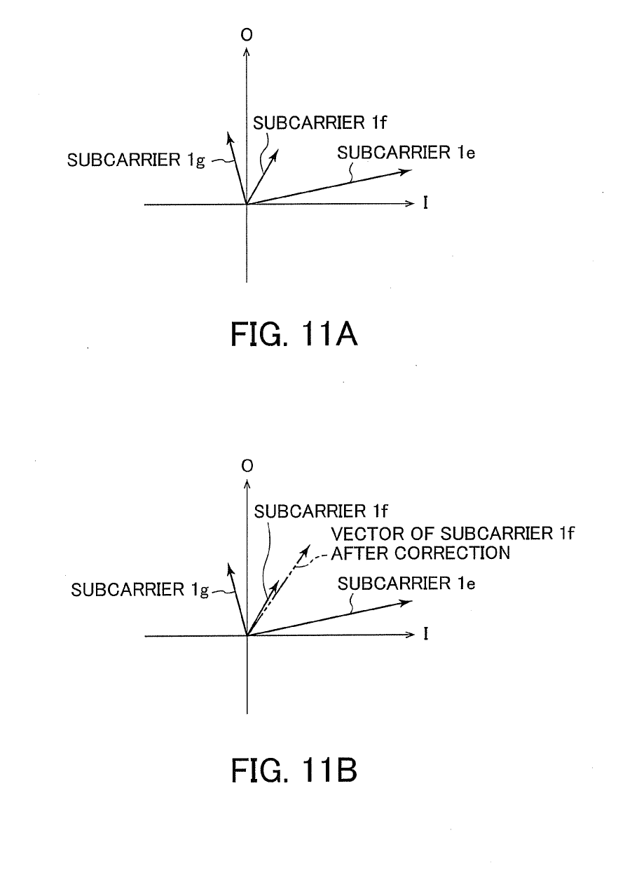

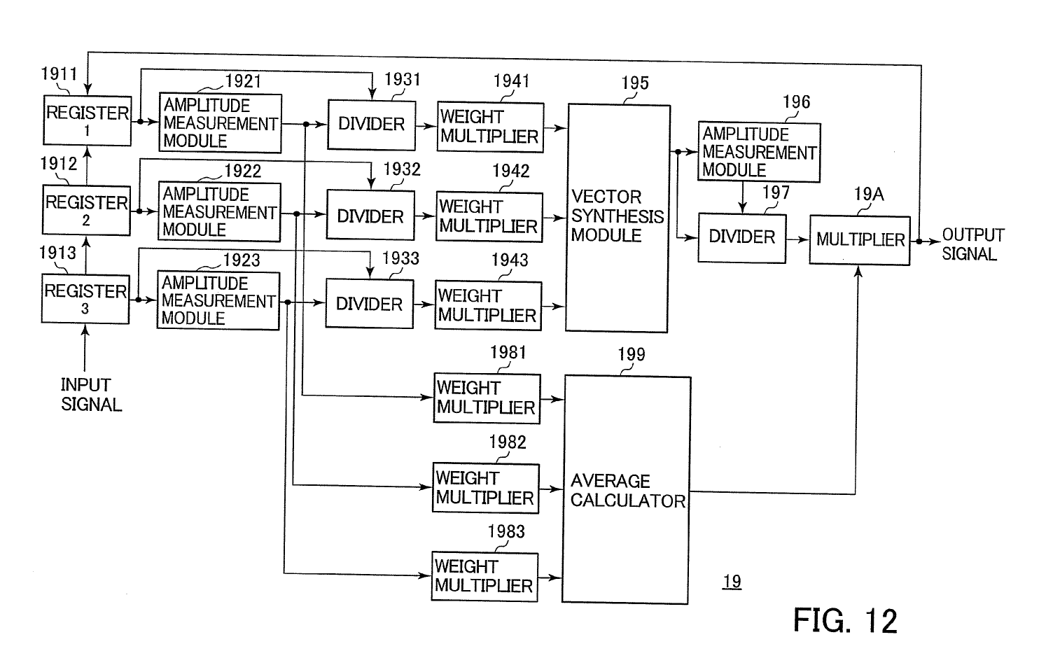

FIGS. 11A and 11B are diagrams for explaining a processing operation of the smoothing module 19. FIG. 11A shows vectors of results of transmission channel response estimation performed by the transmission channel response estimator 14 for subcarriers 1e through 1g which have successive frequencies. How the amplitude and the phase of each vector change in the transmission channel is specifically shown.

The smoothing module 19 appropriately corrects the result of the transmission channel response estimation for the subcarrier if by using the subcarrier 1e whose frequency is higher than the frequency of the subcarrier if and the subcarrier 1g whose frequency is lower than the frequency of the subcarrier if. The corrected result of the transmission channel response estimation for the subcarrier if shown in FIG. 11B is supplied to an equalizer 32.

FIG. 12 is a block diagram showing an example internal structure of the smoothing module 19. The smoothing module 19 includes registers 1911 through 1913, amplitude measurement modules 1921 through 1923, dividers 1931 through 1933, weight multipliers 1941 through 1943, a vector synthesis module 195, an amplitude measurement module 196, a divider 197, weight multipliers 1981 through 1983, an average calculator 199, an amplitude measurement module 198, and a multiplier 19A.

The registers 1911 through 1913 store the results of the transmission channel response estimation for the three successive subcarriers, namely changes of amplitude and phases in the transmission channel. The amplitude measurement modules 1921 through 1923 calculate the amplitudes of the vectors stored in the registers 1911 through 1913, respectively. Using the calculated amplitudes, the dividers 1931 through 1933 convert the vectors stored in the registers 1911 through 1913, respectively, into unit vectors.

The weight multipliers 1941 through 1943 multiply the unit vectors which the dividers 1931 through 1933 generate respectively by predetermined weight coefficients p, q, and r, respectively. Here, the weight coefficients p, q, and r are equal to or greater than 0 but smaller than 1 for the subcarrier 1b whose frequency overlaps with the frequency of the spurious component 2, and are 1 for the subcarriers 1a whose frequencies do not overlap with the frequency of the spurious component 2, for example. Optimum values of such weight coefficients are stored beforehand in the storage 42 as in the first embodiments, and are supplied from the controller 16.

The vector synthesis module 195 synthesizes the three weighted vectors generated by the weight multipliers 1941 through 1943. The amplitude measurement module 196 calculates the amplitude of the synthesized vector generated by the vector synthesis module 195. Using the calculated amplitude, the divider 197 converts the combined vector into a unit vector.

The weight multipliers 1981 through 1983 multiply the amplitudes calculated by the amplitude measurement modules 1921 through 1923 by the above described weight coefficients p, q, and r, respectively. The average calculator 199 calculates the average value of the amplitudes of the weighted vectors. The multiplier 19A multiplies the unit vector generated by the divider 197 by the above average value. In this manner, the results of the transmission channel response estimation for the three subcarriers can be smoothed and corrected.

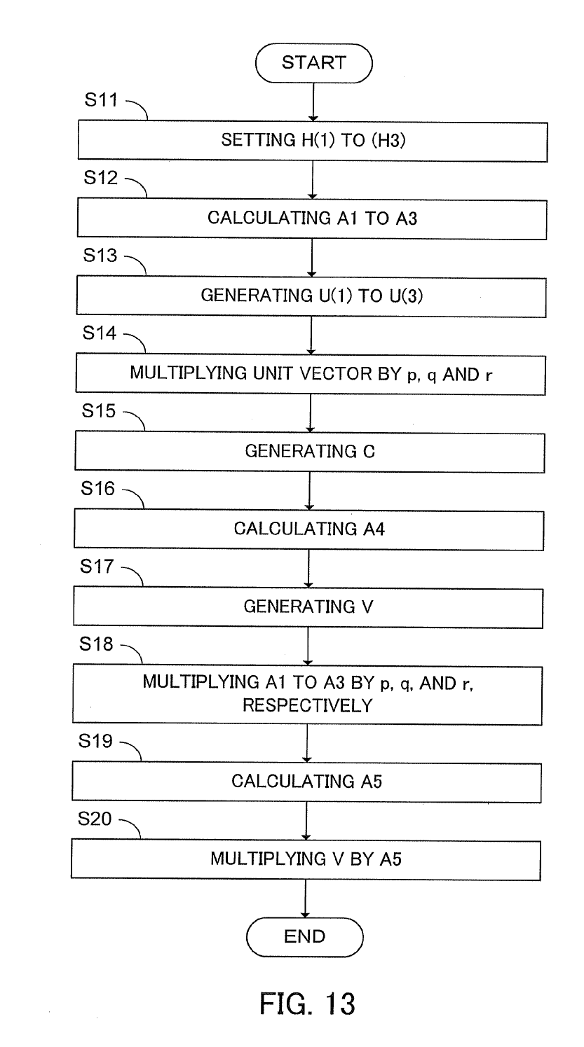

FIG. 13 is a flowchart showing an example of a processing operation of the smoothing module 19.

First, vectors H(1) through H(3) indicating the results of transmission channel response estimation for the three subcarriers at successive frequencies are set in the registers 1911 through 1913, respectively (step S11). Those transmission channel response estimation results are the results of transmission channel response estimation performed on the respective subcarriers by the transmission channel response estimator 14.

The amplitude measurement modules 1921 through 1923 then calculate the amplitudes A1 through A3 of the set vectors H(1) through H(3), respectively (step S12). Using the amplitudes A1 through A3, the dividers 1931 through 1933 generate unit vectors U(1) through U(3) of the vectors H(1) through H(3), respectively (step S13). The unit vectors U(1) through U(3) are expressed by the following equations (1).

U(1)=H(1)/A1=H(1)/|E1(1)|

U(2)=H(2)/A2=H(2)/|H(2)|

U(3)=H(3)/A3=H(3)/|H(3)| (1)

The weight multipliers 1941 through 1943 multiply the unit vectors U(1) through U(3) by the weight coefficients p, q, and r supplied from the controller 16, respectively (step S14). Further, the vector synthesis module 195 synthesizes the unit vectors U(1) through U(3) multiplied by the weight coefficients p, q, and r, respectively, to generate a synthesized vector C (step S15). The combined vector C is expressed by the following equation (2).

C=p*U(1)+q*U(2)+r*U(3) (2).

Further, the amplitude measurement module 196 calculates the amplitude A4 of the synthesized vector C (step S16). Using the amplitude A4, the divider 197 generates a unit vector V of the synthesized vector C (step S17). The unit vector V is expressed by the following equation (3).

V=C/A4={p*U(1)+q*U(2)+r*U(3)}/A4 (3)

Meanwhile, the weight multipliers 1981 through 1983 multiply the amplitudes A1 through A3 by the weight coefficients p, q, and r supplied from the controller 16, respectively (step S18). Further, the average calculator 199 calculates the average value A5 of the amplitudes A1 through A3 multiplied by the weight coefficients p, q, and r (step S19). The average value A5 is expressed by the following equation (4).

A5=(p*A1+q*A2*r*A3)/(p+q+r) (4)

The multiplier 19A then multiplies the unit vector V by the average value A5, to generate a smoothed vector H as the transmission channel responses of the subcarriers (step S20). The vector H is expressed by the following equation (5).

H=A5*V (5)

This vector H may be set in the register 1911, and be used to smooth the results of the next transmission channel response estimation subcarriers at successive frequencies.

As transmission channel response estimation results are smoothed by such an operation, transmission channel responses can be corrected with high precision. The corrected transmission channel response estimation results are used at the equalizer 32.

Although the results of transmission channel response estimation for the three subcarriers are smoothed in the example shown in FIGS. 11A and 11B, results of transmission channel response estimation performed on two subcarriers or four or more subcarriers may be smoothed.

Also, in FIG. 10, the weight multiplier 17 may perform a weight multiplication process under the control of the controller 16, as in the first embodiment.

As described above, in the second embodiment, transmission channel response results are corrected by performing a smoothing process on the results of transmission channel response estimation performed for the respective subcarriers independently of one another, with the transmission channel response results of the subcarriers at adjacent frequencies being taken into account. In this smoothing process, the subcarrier whose frequency overlaps with the frequency of the spurious component 2 is multiplied by a weight coefficient that is smaller than 1. Accordingly, influence of the spurious component 2 can be reduced, and transmission channel responses can be estimated with high precision.

At least a part of the reception apparatus explained in the above embodiments can be formed of hardware or software. When the reception apparatus is partially formed of the software, it is possible to store a program implementing at least a partial function of the reception apparatus in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the reception apparatus can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A reception apparatus configured to receive a radio signal comprising a plurality of modulated subcarriers, the reception apparatus comprising:
a demodulator configured to demodulate the radio signal to generate the subcarriers;
a subcarrier specification module configured to specify a subcarrier whose frequency overlaps with a spurious frequency among the subcarriers; and
an error correction decoder configured to perform error correction, relying more on the subcarriers whose frequencies do not overlap with the spurious frequency than on the subcarrier whose frequency overlaps with the spurious frequency.

2. The reception apparatus of claim 1, wherein the spurious frequency is derived from a clock signal used in the reception apparatus or a source oscillation signal of the clock signal.

3. The reception apparatus of claim 2, wherein the subcarrier specification module is configured to specify a subcarrier whose frequency is substantially equal to an integral multiple of a frequency of one of the clock signal used in the reception apparatus and the source oscillation signal of the clock signal.

4. The reception apparatus of claim 1, further comprising:
a weight multiplier configured to multiply the specified subcarrier by a weight coefficient equal to or greater than 0 but smaller than 1,
wherein the error correction decoder performs the error correction by using the subcarrier multiplied by the weight coefficient.

5. The reception apparatus of claim 4, wherein the weight coefficient is set in accordance with at least one of a communication rate, a temperature in the reception apparatus, a power supply voltage of the reception apparatus, and a reception intensity of the radio signal.

6. The reception apparatus of claim 4, wherein the weight multiplier is configured to multiply subcarriers whose frequency is symmetrical with respect to a center frequency among the subcarriers by the weight coefficient.

7. The reception apparatus of claim 4, wherein the weight multiplier is configured to multiply a plurality of subcarriers whose frequencies are at regular intervals by the weight coefficient.

8. The reception apparatus of claim 1, further comprising:
a transmission channel response estimator configured to estimate a transmission channel response of each of the subcarriers using a reference signal contained in the radio signal,
wherein the subcarrier specification module is configured to specify the subcarrier whose frequency overlaps with the spurious frequency based on the estimated transmission channel response.

9. The reception apparatus of claim 1, further comprising:
a transmission channel response estimator configured to estimate a transmission channel response of each of the subcarriers using a reference signal contained in the radio signal; and
a smoothing module configured to correct a transmission channel response estimation result by smoothing at least two transmission channel response estimation results, relying more on a result of the transmission channel response estimation performed for the subcarriers whose frequencies do not overlap with the spurious frequency than on a result of the transmission channel response estimation performed for the subcarrier whose frequency overlap with the spurious frequency.

10. A reception apparatus configured to receive a radio signal comprising a plurality of modulated subcarriers, the reception apparatus comprising:
a demodulator configured to demodulate the radio signal to generate the subcarriers;
a subcarrier specification module configured to specify a subcarrier whose frequency overlaps with a spurious frequency among the subcarriers;
a transmission channel response estimator configured to estimate a transmission channel response of each of the subcarriers by using a reference signal contained in the radio signal; and
a smoothing module configured to correct a transmission channel response estimation result by smoothing at least two transmission channel response estimation results, relying more on a result of the transmission channel response estimation performed for the subcarriers whose frequencies do not overlap with the spurious frequency than on a result of the transmission channel response estimation performed for the subcarrier whose frequency overlaps with the spurious frequency,
wherein the demodulator comprises an equalizer configured to correct distortion caused in the radio signal in the transmission channel, taking into account the corrected transmission channel response estimation result.

11. The reception apparatus of claim 10, wherein the spurious frequency is derived from a clock signal used in the reception apparatus or a source oscillation signal of the clock signal.

12. The reception apparatus of claim 11, wherein the subcarrier specification module is configured to specify a subcarrier whose frequency is substantially equal to an integral multiple of a frequency of the clock signal used in the reception apparatus or the source oscillation signal of the clock signal.

13. The reception apparatus of claim 10, wherein the subcarrier specification module is configured to specify the subcarrier whose frequency overlaps with the spurious frequency based on the estimated transmission channel response.

14. A reception method to receive a radio signal comprising a plurality of modulated subcarriers, the reception method comprising:
demodulating the radio signal to generate the subcarriers;
specifying a subcarrier whose frequency overlaps with a spurious frequency among the subcarriers; and
performing error correction, relying more on the subcarriers whose frequencies do not overlap with the spurious frequency than on the subcarrier whose frequency overlaps with the spurious frequency.

15. The reception method of claim 14, wherein the spurious frequency is derived from a clock signal used in a reception apparatus to receive the radio signal or a source oscillation signal of the clock signal.

16. The reception method of claim 15, wherein upon specifying the subcarrier, a subcarrier whose frequency is substantially equal to an integral multiple of a frequency of the clock signal used in the reception apparatus or the source oscillation signal of the clock signal, is specified.

17. The reception method of claim 14, further comprising:
multiplying the specified subcarrier by a weight coefficient equal to or greater than 0 but smaller than 1,
wherein upon performing the error correction, the error correction is performed by using the subcarrier multiplied by the weight coefficient.

18. The reception method of claim 14, further comprising:
estimating a transmission channel response of each of the subcarriers using a reference signal contained in the radio signal,
wherein upon specifying the subcarrier, the subcarrier the subcarrier whose frequency overlaps with the spurious frequency is specified based on the estimated transmission channel response.

19. The reception method of claim 14, further comprising:
estimating a transmission channel response of each of the subcarriers using a reference signal contained in the radio signal; and
correcting a transmission channel response estimation result by smoothing at least two transmission channel response estimation results, relying more on a result of the transmission channel response estimation performed for the subcarriers whose frequencies do not overlap with the spurious frequency than on a result of the transmission channel response estimation performed for the subcarrier whose frequency overlaps with the spurious frequency.
